(19) United States
(12) Patent Application Publication
(10) Pub. No.: US 2024/0220574 A1
(43) Pub. Date: Jul. 4, 2024

(54) DSP BASED COMPUTE ENGINE FOR EXECUTING MATRIX OPERATIONS

(71) Applicant: Meta Platforms Technologies, LLC, Menlo Park, CA (US)

(72) Inventors: Shiyu Liu, Sunnyvale, CA (US); Soroush Heidari, Sunnyvale, CA (US); Tomonari Tohara, Sunnyvale, CA (US); Reza Tusi, San Jose, CA (US); Javid Jaffari, San Diego, CA (US)

(21) Appl. No.: 18/525,466

(22) Filed: Nov. 30, 2023

Related U.S. Application Data
(60) Provisional application No. 63/477,542, filed on Dec. 28, 2022.

(51) Int. Cl. G06F 17/16

(52) U.S. Cl. CPC G06F 17/16

(57) ABSTRACT

A method implemented by a digital signal processor (DSP) including application-specific processing engines is provided. The method includes accessing, by the application-specific processing engines a configurable microcode. The configurable microcode includes a set of instructions configured to cause the application-specific processing engines to execute a matrix-based arithmetic algorithm. The method includes executing, by the application-specific processing engines, and based on the configurable microcode, the matrix-based arithmetic algorithm. Executing the matrix-based arithmetic algorithm includes receiving, by the application-specific processing engines, one or more input matrices, performing, by the application-specific processing engines, a plurality of computations based on the one or more input matrices by iteratively executing one or more of a predetermined set of arithmetic operations until the execution of the matrix-based arithmetic algorithm is completed, and generating, by the application-specific processing engines, an output corresponding to the completed execution of the matrix-based arithmetic algorithm.

### PRIORITY

This application claims the benefit under 35 U.S.C. § 119(c) of U.S. Provisional Patent Application No. 63/477,542, filed 28 Dec. 2022, which is incorporated herein by reference.

### TECHNICAL FIELD

This disclosure generally relates to a digital signal processor (DSP), and, more specifically, to a DSP based compute engine for efficiently executing matrix operations.

### BACKGROUND

Embedded applications, such as a sensor and processing resources for extended-reality (XR) systems (e.g., virtual-reality (VR) systems, augmented-reality (AR) systems, mixed-reality (MR) systems, and so forth), may typically rely on digital signal processors (DSPs). For example, DSPs are suitable for power and energy constrained domains with real-time performance requirements, and thus design of DSPs generally optimizes for power efficiency over programmability and software compatibility. For performance, DSP architectures may utilize very long instruction word (VLIW)) to take advantage of instruction level parallelism (IPL) or single input multiple data (SIMD) to take advantage of data parallelism. However, while SIMD architectures may allow the DSPs to perform well by taking advantage of data parallelism, the DSPs may nevertheless lack flexibility and performance efficiency in executing matrix operations or other linear algebra based operations.

### SUMMARY OF CERTAIN EMBODIMENTS

The present embodiments are directed to techniques for providing a digital signal processor (DSP) system including a DSP and one or more application-specific processing engines based thereon for efficiently executing matrix operations (e.g., one or more Basic Linear Algebra Subroutines (BLAS)). In certain embodiments, the one or more application-specific processing engines may access, from a memory of the DSP system, a configurable microcode. For example, in some embodiments, the configurable microcode may include a set of instructions configured to cause the one or more application-specific processing engines to execute a matrix-based arithmetic algorithm. In certain embodiments, the one or more application-specific processing engines may then execute, based on the configurable microcode, the matrix-based arithmetic algorithm. For example, in one embodiment, executing the matrix-based arithmetic algorithm may include executing, based on the configurable microcode, one or more of a Cholesky decomposition algorithm, a general matrix multiplication (GeMM) algorithm, a triangular solve matrix (TRSM) algorithm, or a triangular matrix matrix multiplication (TRMM) algorithm.

In certain embodiments, the one or more application-specific processing engines may execute the matrix-based arithmetic algorithm by receiving one or more input matrices, performing a plurality of computations based on the one or more input matrices by iteratively executing one or more of a predetermined set of arithmetic operations until the execution of the matrix-based arithmetic algorithm is completed, and generating an output corresponding to the completed execution of the matrix-based arithmetic algorithm. For example, in some embodiments, the predetermined set of arithmetic operations may include one or more of a multiplication operation, a reciprocal square root operation, or a reciprocal function operation. In certain embodiments, the one or more application-specific processing engines may include an arithmetic logic unit (ALU) configured to execute the one or more of the predetermined set of arithmetic operations.

In certain embodiments, the one or more application-specific processing engine may receive a 2×2 input matrix, a 4×4 input matrix, or an 8×8 input matrix. In certain embodiments, the configurable microcode may be reconfigured. For example, in certain embodiments, the one or more application-specific processing engines may access, from the memory of the DSP system, the reconfigured microcode, and execute, based on the reconfigured microcode, a second matrix-based arithmetic algorithm. In one embodiment, the matrix-based arithmetic algorithm may be a first matrix-based arithmetic algorithm, and the second matrix-based arithmetic algorithm executed based on the reconfigured microcode may be different from the first matrix-based arithmetic algorithm executed based on the microcode. In certain embodiments, the output corresponding to the completed execution of the matrix-based arithmetic algorithm matrix may be stored to the memory of the DSP system.

The embodiments disclosed herein are only examples, and the scope of this disclosure is not limited to them. Certain embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example extended reality (XR) system.

FIG. 1B illustrates another example extended reality (XR) system.

FIG. 2 illustrates a digital signal processor (DSP) system including a DSP and one or more application-specific processing engines.

FIGS. 3A-3D illustrate example embodiments of an application-specific processing engine.

FIGS. 4A-4C illustrate diagrammatic examples of executing respective matrix-based arithmetic algorithms.

FIG. 5 illustrates a diagrammatic example of utilizing compute primitives to compute one or more matrix-based arithmetic algorithms.

FIG. 6 is a flow diagram of a method for providing a digital signal processor (DSP) system including a DSP and one or more application-specific processing engines based thereon for efficiently executing matrix operations.

FIG. 7 illustrates an example computer system.

### DESCRIPTION OF EXAMPLE EMBODIMENTS

Embedded applications, such as a sensor and processing resources for extended reality (XR) systems (e.g., virtual reality (VR) systems, augmented reality (AR) systems, mixed reality (MR) systems, and so forth), may typically rely on digital signal processors (DSPs). For example, DSPs are suitable for power and energy constrained domains with real-time performance requirements, and thus design of DSPs generally optimizes for power efficiency over programmability and software compatibility. For performance, DSP architectures may utilize very long instruction word (VLIW)) to take advantage of instruction level parallelism (IPL) or single input multiple data (SIMD) to take advantage of data parallelism. However, while SIMD architectures may allow the DSPs to perform well by taking advantage of data parallelism, the DSPs may nevertheless lack flexibility and performance efficiency in executing matrix operations or other linear algebra based operations.

Accordingly, the present embodiments are directed to techniques for providing a digital signal processor (DSP) system including a DSP and one or more application-specific processing engines based thereon for efficiently executing matrix operations (e.g., one or more Basic Linear Algebra Subroutines (BLAS)). In certain embodiments, the one or more application-specific processing engines may access, from a memory of the DSP, a configurable microcode. For example, in some embodiments, the configurable microcode may include a set of instructions configured to cause the one or more application-specific processing engines to execute a matrix-based arithmetic algorithm. In certain embodiments, the one or more application-specific processing engines may then execute, based on the configurable microcode, the matrix-based arithmetic algorithm. For example, in one embodiment, executing the matrix-based arithmetic algorithm may include executing, based on the configurable microcode, one or more of a Cholesky decomposition algorithm, a general matrix multiplication (GeMM) algorithm, or a triangular solve matrix (TRSM) algorithm.

In certain embodiments, the one or more application-specific processing engines may execute the matrix-based arithmetic algorithm by receiving one or more input matrices, performing a plurality of computations based on the one or more input matrices by iteratively executing one or more of a predetermined set of arithmetic operations until the execution of the matrix-based arithmetic algorithm is completed, and generating an output corresponding to the completed execution of the matrix-based arithmetic algorithm. For example, in some embodiments, the predetermined set of arithmetic operations may include one or more of a multiplication operation, a reciprocal square root operation, or a reciprocal function operation. In certain embodiments, the one or more application-specific processing engines may include an arithmetic logic unit (ALU) configured to execute the one or more of the predetermined set of arithmetic operations.

In certain embodiments, the one or more application-specific processing engine may receive a 2×2 input matrix, a 4×4 input matrix, or an 8×8 input matrix. In certain embodiments, the configurable microcode may be reconfigured. For example, in certain embodiments, the one or more application-specific processing engines may access, from the memory of the DSP, the reconfigured microcode, and execute, based on the reconfigured microcode, a second matrix-based arithmetic algorithm. In one embodiment, the matrix-based arithmetic algorithm may be a first matrix-based arithmetic algorithm, and the second matrix-based arithmetic algorithm executed based on the reconfigured microcode may be different from the first matrix-based arithmetic algorithm executed based on the microcode. In certain embodiments, the output corresponding to the completed execution of the matrix-based arithmetic algorithm matrix may be stored to the memory of the DSP.

Thus, in accordance with the presently disclosed embodiments, the one or more application-specific processing engines may efficiently execute (e.g., over a reduced number of clock cycles) a matrix-based arithmetic algorithm (e.g., Cholesky decomposition algorithm, GeMM algorithm, TRSM algorithm, TRMM algorithm) by exploiting and computing uncomplex arithmetic operations (e.g., one or more of a multiplication operation, a reciprocal square root operation, or a reciprocal function operation) and performing single cycle executions of the arithmetic operations. Additionally, by providing a configurable or reconfigurable microcode, the one or more application-specific processing engines may be utilized to execute any of various matrix-based arithmetic algorithms and/or Basic Linear Algebra Subroutines (BLAS) (e.g., BLAS level 1, BLAS level 2, BLAS level 3, and so forth) without having to reconfigure any of the hardware circuitry associated with the DSP and/or the one or more application-specific processing engines.

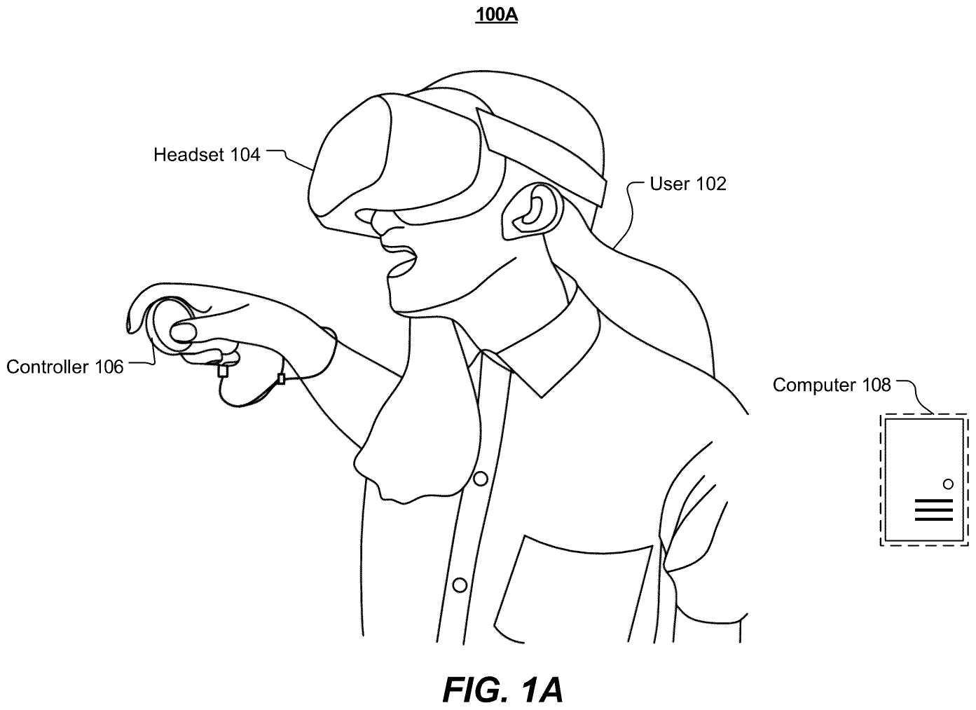

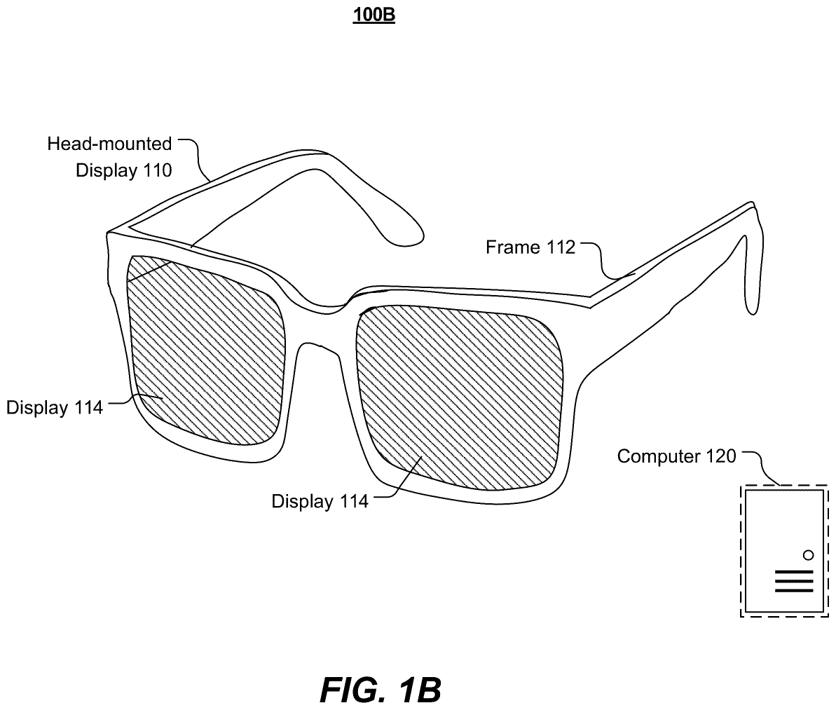

FIG. 1A illustrates an example extended reality (XR) system 100A, in accordance with the presently disclosed embodiments. In certain embodiments, the XR system 100A may include, for example, a virtual-reality (VR) system, an augmented-reality (AR) system, a mixed-reality (MR) system, and/or other similar XR system. In certain embodiments, the XR system 100A may include a headset 104, a controller 106, and a computing system 108. A user 102 may wear the headset 104 that may display visual XR content to the user 102. The headset 104 may include an audio device that may provide audio XR content to the user 102. The headset 104 may include one or more cameras which can capture images and videos of environments. The headset 104 may include an eye tracking system to determine the vergence distance of the user 102. The headset 104 may be referred as a head-mounted display (HDM).

In certain embodiments, the controller 106 may include a trackpad and one or more buttons. The controller 106 may receive inputs from the user 102 and relay the inputs to the computing system 108. The controller 206 may also provide haptic feedback to the user 102. The computing system 108 may be connected to the headset 104 and the controller 106 through cables or wireless connections. The computing system 108 may control the headset 104 and the controller 106 to provide the XR content to and receive inputs from the user 102. The computing system 108 may be a standalone host computer system, an on-board computer system integrated with the headset 104, a mobile device, or any other hardware platform capable of providing XR content to and receiving inputs from the user 102.

FIG. 1B illustrates an example XR system 100B, in accordance with the presently disclosed embodiments. The XR system 100B may include a head-mounted display (HMD) 110 (e.g., glasses) including a frame 112, one or more displays 114, and a computing system 120. The displays 114 may be transparent or translucent allowing a user wearing the HMD 110 to look through the displays 114 to see the real world and displaying visual XR content to the user at the same time. The HMD 110 may include an audio device that may provide audio XR content to users. The HMD 110 may include one or more cameras which can capture images and videos of environments. The HMD 110 may include an eye tracking system to track the vergence movement of the user wearing the HMD 110.

In certain embodiments, the XR system 100B may further include a controller 106 including a trackpad and one or more buttons. The controller 106 may receive inputs from users and relay the inputs to the computing system 120. The controller 106 may also provide haptic feedback to users. The computing system 120 may be connected to the HMD 110 and the controller through cables or wireless connections. The computing system 120 may control the HMD 110 and the controller 106 to provide the XR content to and receive inputs from users. The computing system 120 may be a standalone host computer system, an on-board computer system integrated with the HMD 110, a mobile device, or any other hardware platform capable of providing XR content to and receiving inputs from users.

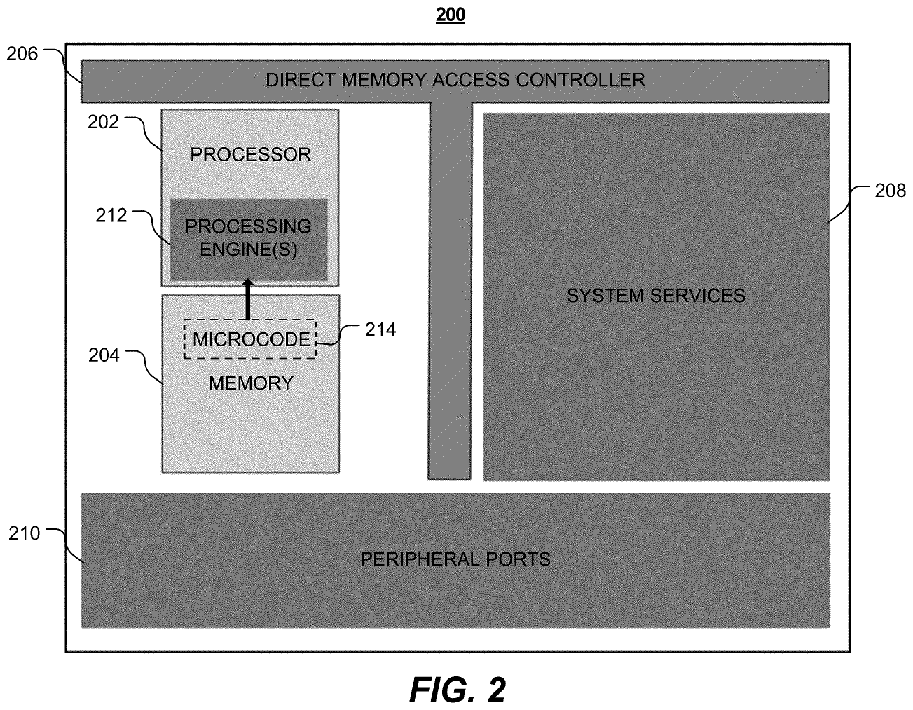

FIG. 2 illustrates a digital signal processor (DSP) system 200, in accordance with the presently disclosed embodiments. In one embodiment, the DSP system 200 may be included within the HMD 110, the computing system 108, and/or the computing system 120 as discussed above with respect to FIGS. 1A and 1B. As depicted by FIG. 2, in certain embodiments, the DSP system 200 may include a processor 202, a memory 204, a direct memory access (DMA) controller 206, system services 208, and peripheral ports 210. In certain embodiments, the processor 202 may include a digital signal processor (DSP) or similar processor architecture suitable for processing and supporting any of various dynamic multimedia workloads and applications, such as extended reality (e.g., virtual reality (VR), augmented reality (AR), mixed reality (MR), and so forth), video conferencing, visualization, 3D graphics, animation, speech processing and recognition, and so forth. In one embodiment, the processor 202 may include a DSP that increases performance by utilizing a very long instruction word (VLIW) architecture, which takes advantage of instruction level parallelism (IPL). In another embodiment, the processor 202 may include a DSP that increases performance by utilizing a single input multiple data (SIMD) architecture, which takes advantage of data parallelism.

In certain embodiments, the memory 204 may include any on-chip memory (e.g., read-only memory (ROM), random access memory (RAM), dynamic random access memory (DRAM), static random access memory (SRAM), dual-access random access memory (DARAM), and so forth) that may store instructions, routines, or subroutines that may be accessed and transferred (e.g., in parallel) by the DMA controller 206 and executable by the processor 202 (e.g., DSP). In certain embodiments, the system services 208 may include, for example, any real-time clocks (RTCs), oscillators, regulators, pin multiplexers (MUXs), hardware accelerators, buses, or similar components or services that may be utilized to synchronize, regulate, and control state of operations of the processor 202 (e.g., DSP). In certain embodiments, the peripheral ports 210 may include, for example, any serial ports or other peripherals (e.g., USB, SPI, eMMC/SD, UART, i2C, and so forth) by which data may be received by the DSP system 200 and/or transmitted by the DSP system 200.

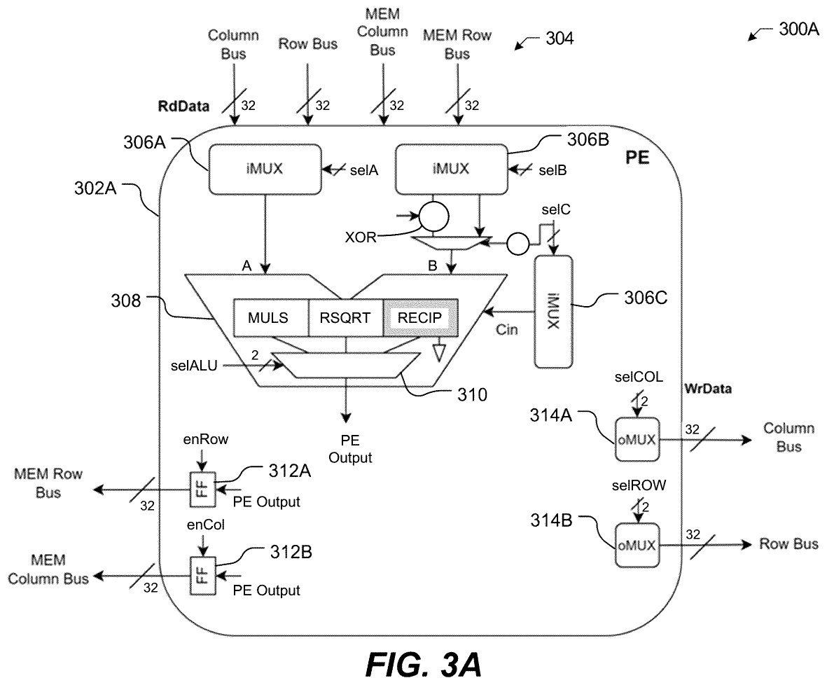

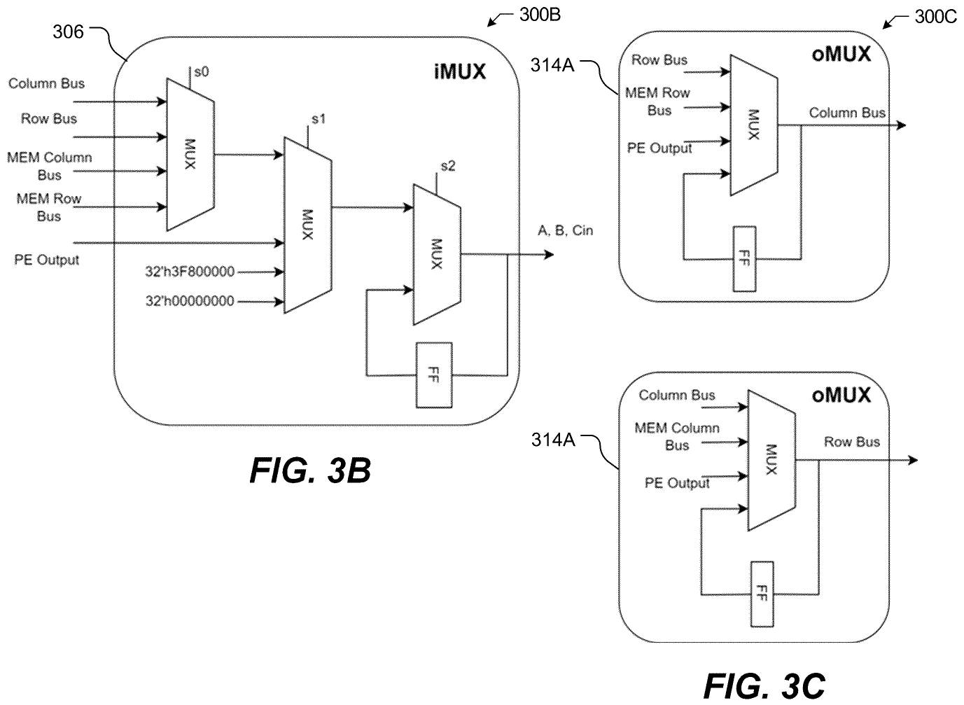

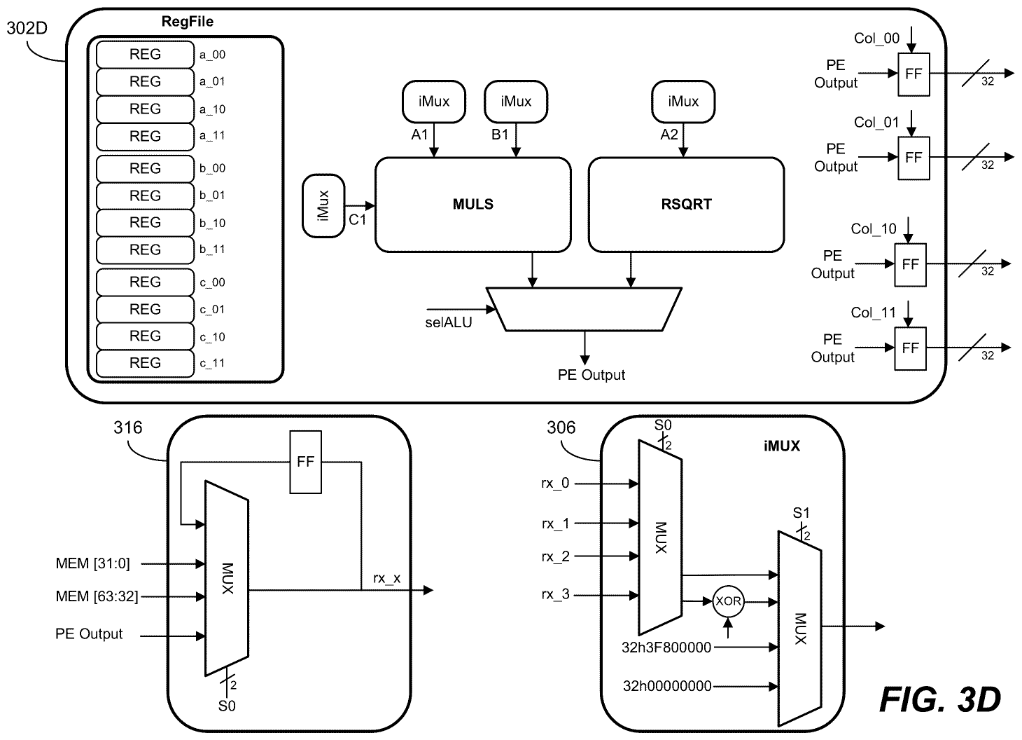

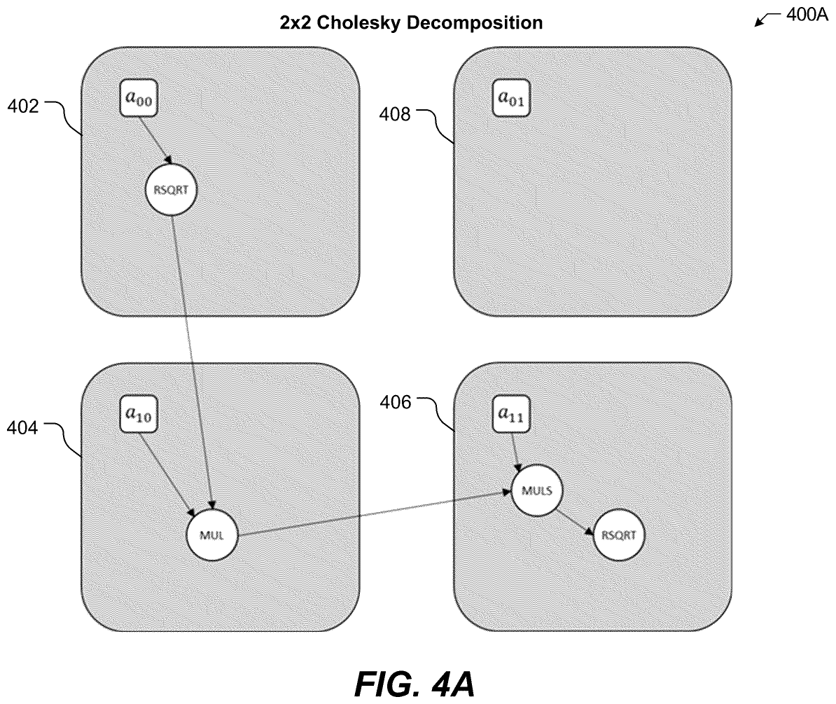

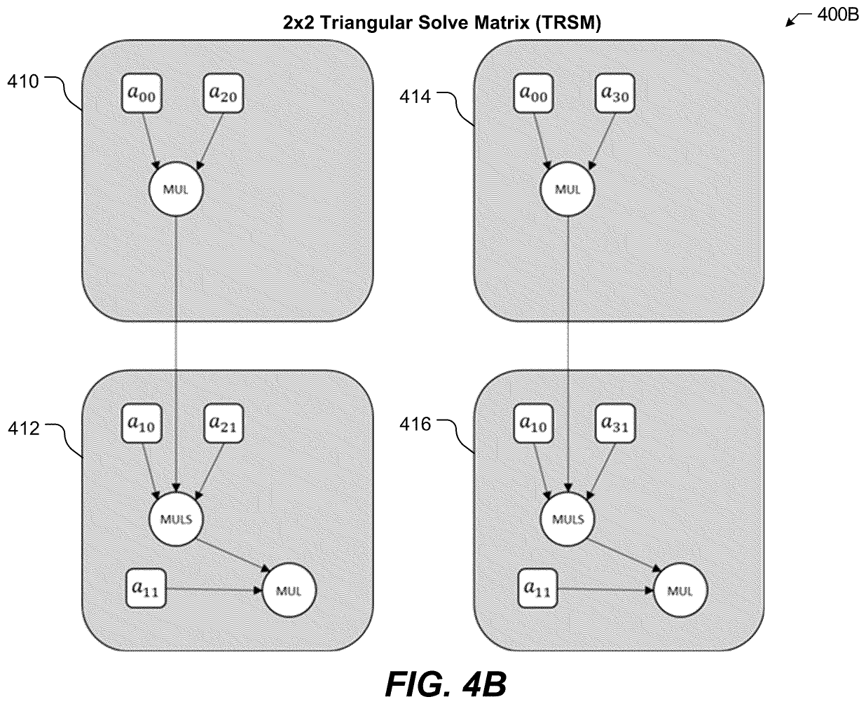

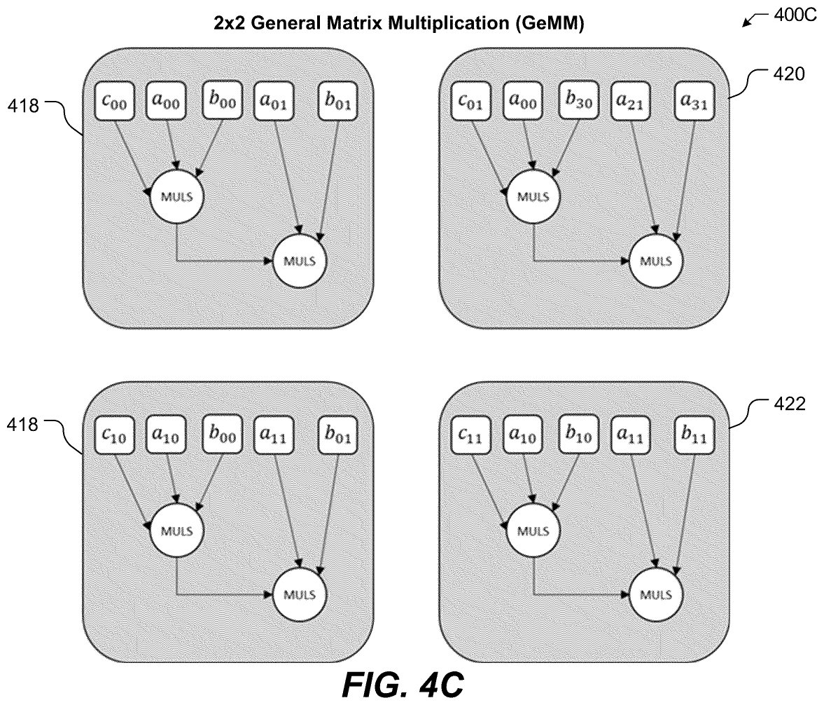

In certain embodiments, as further depicted by the DSP system 200, the processor 202 (e.g., DSP) may include one or more application-specific processing engines 212. For example, in some embodiments, the one or more application-specific processing engines 212 may include any digital processor that may be suitable for being implemented and executed on the processor 202. For example, as will be further appreciated below with respect to FIGS. 3A-3D and 4A-4C, in accordance with the presently disclosed embodiments, the one or more application-specific processing engines 212 may include digital logic circuitry or other similar digital circuitry that may be utilized to efficiently execute matrix operations (e.g., one or more Basic Linear Algebra Subroutines (BLAS)). Specifically, in accordance with the presently disclosed embodiments, the one or more application-specific processing engines 212 may include a specialized circuitry (e.g., including its own compute and memory resources) that may be included as part of the processor 202 (e.g., DSP), and that may operate at least partially independent of the processor 202 (e.g., DSP). For example, in one embodiment, the one or more application-specific processing engines 212 may execute matrix operations (e.g., one or more Basic Linear Algebra Subroutines (BLAS)) while the processor 202 (e.g., DSP) concurrently performs other workloads or tasks unrelated to executing matrix operations.

In certain embodiments, as further depicted by the DSP system 200, the memory 204 may store a microcode 214. For example, in some embodiments, the microcode 214 may include a configurable or reconfigurable instruction set (e.g., a configurable or reconfigurable software routine), which may be accessed by the one or more application-specific processing engines 212 and utilized by the one or more application-specific processing engines 212 to execute a matrix-based arithmetic algorithm. For example, in one embodiment, the microcode 214 may include a configurable or reconfigurable instruction set (e.g., a configurable or reconfigurable software routine) to be executed by the one or more application-specific processing engines 212 to execute a matrix-based arithmetic algorithm, such as a Cholesky decomposition algorithm, a general matrix multiplication (GeMM) algorithm, a triangular solve matrix (TRSM) algorithm, a triangular matrix matrix multiplication (TRMM) algorithm, or other similar Basic Linear Algebra Subroutines (BLAS).

Specifically, as will be further appreciated below with respect to FIGS. 3A-3D and 4A-4C, the one or more application-specific processing engines 212 may efficiently execute (e.g., over a reduced number of clock cycles) a matrix-based arithmetic algorithm (e.g., Cholesky decomposition algorithm, GeMM algorithm, TRSM algorithm, TRMM algorithm) by exploiting and computing uncomplex arithmetic operations (e.g., one or more of a multiplication operation, a reciprocal square root operation, or a reciprocal function operation) and performing single cycle executions of the arithmetic operations. Additionally, by providing a configurable or reconfigurable microcode 214, the one or more application-specific processing engines 212 may be utilized to execute any of various matrix-based arithmetic algorithms and/or Basic Linear Algebra Subroutines (BLAS) (e.g., BLAS level 1, BLAS level 2, BLAS level 3, and so forth) without having to reconfigure any of the hardware circuitry associated with the processor 202 (e.g., DSP) and/or the one or more application-specific processing engines 212.

FIGS. 3A-3D illustrate embodiments of an application-specific processing engine 300A, 300B, 300C, and 300D, in accordance with the presently disclosed embodiments. In certain embodiments, embodiments of the application-specific processing engine 300A, 300B, 300C, and 300D may be utilized to efficiently execute (e.g., over a reduced number of clock cycles) a matrix-based arithmetic algorithm (e.g., Cholesky decomposition algorithm, GeMM algorithm, TRSM algorithm, TRMM algorithm) by exploiting and computing uncomplex arithmetic operations (e.g., one or more of a multiplication operation, a reciprocal square root operation, or a reciprocal function operation) and performing single cycle executions of the arithmetic operations. Specifically, in some examples, embodiments of the application-specific processing engine 300A, 300B, 300C, and 300D may execute a matrix-based arithmetic algorithm by iteratively computing the uncomplex arithmetic operations (e.g., one or more of a multiplication operation, a reciprocal square root operation, or a reciprocal function operation) until the execution of the matrix-based arithmetic algorithm is completed.

As an example, a matrix-based arithmetic algorithm, such as a Cholesky decomposition algorithm, may transform a positive definitive original matrix A into a form A=LL^{T} where L is a triangular matrix (e.g., upper or lower triangular matrix). Thus, in some examples, the Cholesky decomposition (e.g., A=LL^{T}) includes computing the triangular matrix L and inverting the triangular matrix L. In certain embodiments, the inversion of the triangular matrix L may be derived by executing an inverse of original matrix A, which may be derived by computing A⁻¹=L⁻¹ (L⁻¹)^{T}. In certain embodiments, whenever the triangular matrix L is a given, then Ax=b may be derived. For example, when the triangular matrix L is a given, L^{T}y=b may be first derived, and then Lx=y may be derived.

In certain embodiments, the triangular matrix L may be then derived by commencing with a row having one unknown element, and, after the row having one unknown element is derived, the derived value is substituted to the next row having two unknown elements, and, after the row having two unknown elements derived, the two derived values are substituted to the next row having three unknown elements, and so on so forth until a final row of the triangular matrix L is derived. Thus, upon the derivation of the values for the unknown elements of each row of the triangular matrix L, then the final row of the triangular matrix L may be completely derived. Thus, in certain embodiments, the triangular matrix L may be computed for diagonal matrix elements and non-diagonal matrix elements, respectively, as set forth below:

$${l}_{ii} = \sqrt{{a}_{i i} - {\sum }_{k = 1}^{i - 1} {l}_{i k}^{2}}$$

$${l}_{ij} = \frac{1}{{l}_{jj}} ( {a}_{ij} - {\sum }_{k = 1}^{j - 1} {l}_{i k} {l}_{jk} ) .$$

Accordingly, as may be appreciated by the foregoing, in accordance with the presently disclosed embodiments, the Cholesky decomposition (e.g., A=LL^{T}) and/or other similar matrix-based arithmetic algorithm may be computed by iteratively computing uncomplex arithmetic operations, such as one or more multiplication operations, one or more reciprocal square root operations, and one or more reciprocal function operations until the execution of the Cholesky decomposition (e.g., A=LL^{T}) and/or other similar matrix-based arithmetic algorithm is completed. For example, as provided herein, arithmetic operations otherwise performed over multiple clock cycles, such as division operations, are reduced to single cycle operations by exploiting the reciprocal square root operation (e.g., “RSQRT”) and multiplication operation (e.g., “MULS), as, for example, a division by √x (e.g., for computing diagonal matrix elements) may be substituted with multiplication by 1/√x.

In certain embodiments, referring to FIG. 3A, an application-specific processing engine 302A may operate to compute the noted uncomplex arithmetic operations. For example, during operation (e.g., runtime), input signals 304 may be read into the application-specific processing engine 302A. As discussed herein respect to embodiments of the application-specific processing engine 300A, 300B, 300C, and 300D, input and output signals may include, for example, vectors of packed 8-bit, 16-bit, 32-bit, or N-bit integer and/or floating-point values. In some embodiments, the input signals 304 may correspond to one or more input matrices (e.g., a 2×2 input matrix, a 4×4 input matrix, an 8×8 input matrix, or an N×N input matrix). In certain embodiments, input multiplexers (MUXs) 306A and 306B may receive a selection signal to control switching of the MUXs 306A and 306B, which may then output respective selected signals “A” and “B” to an arithmetic logic unit (ALU) 308. In certain embodiments, the ALU 308 may receive a clock input (e.g., “Cᵢₙ”) from the MUX 306C. For example, in one embodiment, the clock input (e.g., “Cᵢₙ”) may include a synchronization signal utilized to synchronize instruction cycles between the ALU 308 and the MUXs 306A and 306B.

In certain embodiments, the ALU 308 may then execute one or more arithmetic operations (e.g., one or more of a multiplication operation “MULS”, a reciprocal square root operation “RSQRT”, or a reciprocal function operation “RECIP”) based on the selected signals “A” and “B” provided by the MUXs 306A and 306B, respectively. In certain embodiments, the ALU 308 may generate outputs corresponding to executions of the arithmetic operations (e.g., one or more of a multiplication operation, a reciprocal square root operation, or a reciprocal function operation). For example, as depicted, the ALU 308 may provide the outputs to a MUX 310, which may also receive a selection ALU input. In certain embodiments, the MUX 310 may select the one of the outputs corresponding to the executions of the arithmetic operations (e.g., one or more of a multiplication operation, a reciprocal square root operation, or a reciprocal function operation) that is suitable and generate a processing engine output (e.g., “PE Output”) based thereon per cycle.

In certain embodiments, the processing engine output (e.g., “PE Output”) may be then passed to flip-flops (FFs) 312A, 312B, which may store the processing engine output (e.g., “PE Output”) to one or more data registers or other memory. In certain embodiments, referring, for example, to FIGS. 3B and 3C, the input MUXs 306A, 306B and output MUXs 314A, 314B may include input and output selectors that may be suitable programmatically register the processing engine output (e.g., “PE Output”) and/or bypassing or discarding the processing engine output (e.g., “PE Output”) per cycle.

In certain embodiments, referring now to FIG. 3D, a less complex (e.g., lower cost in terms of physical area) embodiment of the application-specific processing engine 302D may be presented. As depicted by FIG. 3D, the application-specific processing engine 302D may not include an ALU, and thus arithmetic operations (e.g., one or more of a multiplication operation or a reciprocal square root operation) may be executed on input matrix data (e.g., 2×2 input matrix) accessed directly from a register file 316, which may include an on-chip memory for temporarily storing the input matrix data (e.g., 2×2 input matrix) during operation (e.g., runtime). The register file 316 may also temporarily store the intermediate arithmetic operations outputs during operation.

FIGS. 4A-4C illustrate diagrammatic examples 400A, 400B, and 400C of executing respective matrix-based arithmetic algorithms, in accordance with the presently disclosed embodiments. It should be appreciated that the diagrammatic examples 400A, 400B, and 400C are included merely for the purposes of illustration, and that during operation (e.g., runtime), the matrix-based arithmetic algorithms may be performed and executed in accordance, for example, with the techniques described above with respect to FIGS. 2 and 3A-3D. As depicted by FIG. 4A, the diagrammatic example 400A may illustrate a Cholesky decomposition algorithm as performed utilizing a 2×2 triangular matrix. For example, diagonal and/or non-diagonal matrix elements (e.g., “a₀₀”, “a₁₀”, “a₁₁”) may be computed utilizing multiplication (e.g., “MULS”) and reciprocal square root operation (e.g., “RSQRT”) arithmetic operations iteratively over one or more instruction cycles 402, 404, 406, and 408 or until the execution of the Cholesky decomposition algorithm is completed.

Similarly, as depicted by FIG. 4B, the diagrammatic example 400B may illustrate a TRSM algorithm as performed utilizing a 2×2 triangular matrix. For example, non-diagonal matrix elements (e.g., “a₀₀”, “a₁₀”, a₁₁”, “a₂₀” “a₂₁”, “a₃₀”, “a₃₀”, and so forth) may be computed utilizing multiplication (e.g., “MULS”) and miniature multiplication (e.g., “MUL”) arithmetic operations over instruction cycles 410, 412, 414, and 416 or until the execution of the TRSM algorithm is completed. Lastly, as depicted by FIG. 4C, the diagrammatic example 400C may illustrate a GeMM algorithm as performed utilizing a 2×2 triangular matrix. For example, non-diagonal matrix elements (e.g., “c₀₀”, “a₀₀”, b₀₀”, “a₀₁” “b₀₁”, “c₀₁”, and so forth) may be computed utilizing multiplication (e.g., “MULS”) and miniature multiplication (e.g., “MUL”) arithmetic operations over instruction cycles 418, 420, 422, and 424 or until the execution of the GeMM algorithm is completed.

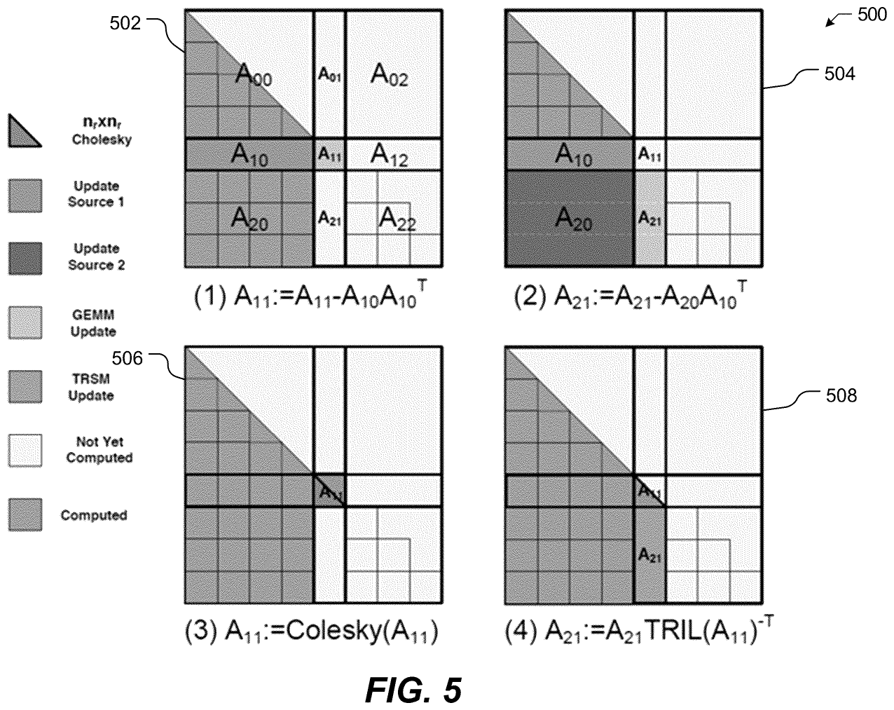

FIG. 5 illustrates a diagrammatic example 500 of utilizing compute primitives to compute one or more matrix-based arithmetic algorithms, in accordance with the presently disclosed embodiments. For example, in certain embodiments, for a given a 2×2 input matrix, compute primitives may be utilized to execute a complete Cholesky decomposition algorithm (e.g., as illustrated by diagrams 502 and 506) a complete TRSM algorithm and a GeMM algorithm (e.g., as illustrated by diagrams 504 and 508).

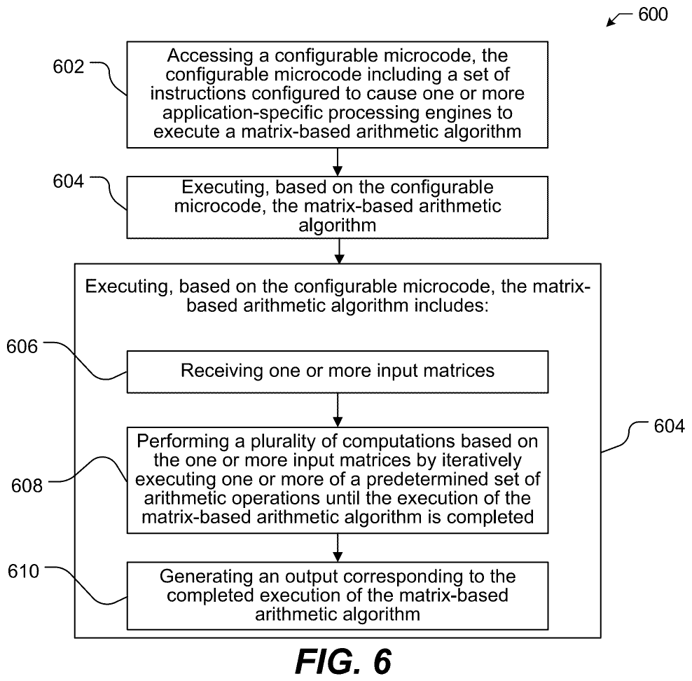

FIG. 6 illustrates is a flow diagram of a method 600 for providing a digital signal processor (DSP) system including a DSP and one or more application-specific processing engines based thereon for efficiently executing matrix operations (e.g., one or more Basic Linear Algebra Subroutines (BLAS)), in accordance with the presently disclosed embodiments. The method 600 may be performed utilizing one or more processors (e.g., DSP processor 202 including one or more application-specific processing engines 212) that may include hardware (e.g., a general purpose processor, a graphic processing units (GPU), an application-specific integrated circuit (ASIC), a system-on-chip (SoC), a microcontroller, a field-programmable gate array (FPGA), or any other processing device(s) that may be suitable for processing image data), software (e.g., instructions running/executing on one or more processors), firmware (e.g., microcode), or any combination thereof.

The method 600 may begin at block 602 with one or more processors (e.g., DSP processor 202 including one or more application-specific processing engines 212) accessing, from a memory of a DSP, a configurable microcode. For example, in certain embodiments, the configurable microcode may include a set of instructions configured to cause one or more application-specific processing engines to execute a matrix-based arithmetic algorithm (e.g., a Cholesky decomposition algorithm, a general matrix multiplication (GeMM) algorithm, a triangular solve matrix (TRSM) algorithm, and so forth). The method 600 may then continue at block 604 with the one or more processors (e.g., DSP processor 202 including one or more application-specific processing engines 212) executing, based on the configurable microcode, the matrix-based arithmetic algorithm.

In particular embodiments, executing, based on the configurable microcode, the matrix-based arithmetic algorithm at block 604 may include the method 600 continuing at block 606 with the one or more processors (e.g., DSP processor 202 including one or more application-specific processing engines) receiving one or more input matrices. For example, in certain embodiments, the one or more input matrices may include a 2×2 input matrix, a 4×4 input matrix, an 8×8 input matrix, or other similar N×N matrix. In certain embodiments, the method 600 may then continue at block 608 with the one or more processors (e.g., DSP processor 202 including one or more application-specific processing engines 212) performing a plurality of computations based on the one or more input matrices by iteratively executing one or more of a predetermined set of arithmetic operations until the execution of the matrix-based arithmetic algorithm is completed.

For example, in some embodiments, the predetermined set of arithmetic operations iteratively executed by the one or more application-specific processing engines 212 may include one or more of a multiplication operation, a reciprocal square root operation, or a reciprocal function operation. In certain embodiments, the one or more application-specific processing engines 212 may include an arithmetic logic unit (ALU) or other suitable accumulator suitable for executing the one or more of the predetermined set of arithmetic operations (e.g., a multiplication operation, a reciprocal square root operation, or a reciprocal function operation). In certain embodiments, the method 600 may then conclude at block 610 with the one or more processors (e.g., DSP processor 202 including one or more application-specific processing engines 212) generating an output corresponding to the completed execution of the matrix-based arithmetic algorithm.

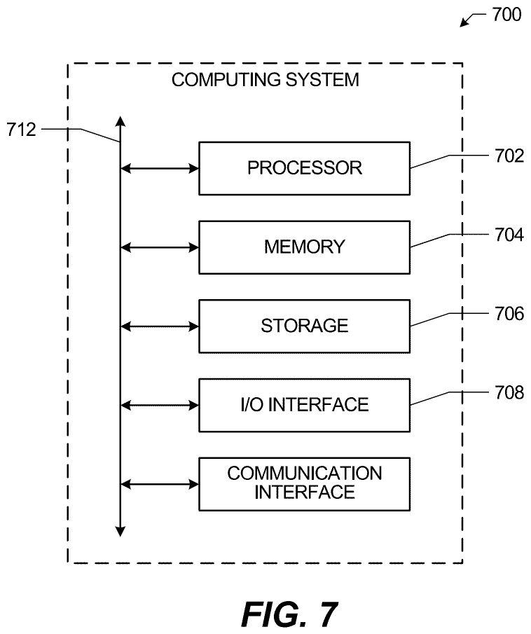

FIG. 7 illustrates an example computer system 700 that may be useful in performing one or more of the foregoing techniques as presently disclosed herein. In certain embodiments, one or more computer systems 700 perform one or more steps of one or more methods described or illustrated herein. In certain embodiments, one or more computer systems 700 provide functionality described or illustrated herein. In certain embodiments, software running on one or more computer systems 700 performs one or more steps of one or more methods described or illustrated herein or provides functionality described or illustrated herein. Certain embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein.

As an example, and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate. In certain embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In certain embodiments, processor 702 includes hardware for executing instructions, such as those making up a computer program. As an example, and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In certain embodiments, processor 702 may include one or more internal caches for data, instructions, or addresses. This disclosure contemplates processor 702 including any suitable number of any suitable internal caches, where appropriate. As an example, and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702.

Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In certain embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In certain embodiments, memory 704 includes main memory for storing instructions for processor 702 to execute or data for processor 702 to operate on. As an example, and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In certain embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere).

One or more memory buses (which may each include an address bus and a data bus) may couple processor 702 to memory 704. Bus 712 may include one or more memory buses, as described below. In certain embodiments, one or more memory management units (MMUs) reside between processor 702 and memory 704 and facilitate accesses to memory 704 requested by processor 702. In certain embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In certain embodiments, storage 706 includes mass storage for data or instructions. As an example, and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In certain embodiments, storage 706 is non-volatile, solid-state memory. In certain embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In certain embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In certain embodiments, communication interface 710 includes hardware, software, or both providing one or more interfaces for communication (such as, for example, packet-based communication) between computer system 700 and one or more other computer systems 700 or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it.

As an example, and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In certain embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates certain embodiments as providing particular advantages, certain embodiments may provide none, some, or all of these advantages.

What is claimed is:

1. A method implemented by a digital signal processor (DSP) including one or more application-specific processing engines implemented on the DSP, the method comprising:
accessing, by the one or more application-specific processing engines, and from a memory of the DSP system, a configurable microcode, wherein the configurable microcode comprises a set of instructions configured to cause the one or more application-specific processing engines to execute a matrix-based arithmetic algorithm; and
executing, by the one or more application-specific processing engines, and based on the configurable microcode, the matrix-based arithmetic algorithm, wherein executing the matrix-based arithmetic algorithm comprises:
receiving, by the one or more application-specific processing engines, one or more input matrices;
performing, by the one or more application-specific processing engines, a plurality of computations based on the one or more input matrices by iteratively executing one or more of a predetermined set of arithmetic operations until the execution of the matrix-based arithmetic algorithm is completed; and
generating, by the one or more application-specific processing engines, an output corresponding to the completed execution of the matrix-based arithmetic algorithm.

2. The method of claim 1, wherein executing the matrix-based arithmetic algorithm comprises executing, by the one or more application-specific processing engines, and based on the configurable microcode, one or more of a Cholesky decomposition algorithm, a general matrix multiplication (GeMM) algorithm, a triangular solve matrix (TRSM) algorithm, or a triangular matrix matrix multiplication (TRMM) algorithm.

3. The method of claim 1, wherein iteratively executing one or more of the predetermined set of arithmetic operations comprises iteratively executing one or more of a multiplication operation, a reciprocal square root operation, or a reciprocal function operation.

4. The method of claim 1, wherein the one or more application-specific processing engines comprises an arithmetic logic unit (ALU) configured to execute the one or more of the predetermined set of arithmetic operations.

5. The method of claim 1, wherein the configurable microcode is reconfigured, and wherein the matrix-based arithmetic algorithm comprises a first matrix-based arithmetic algorithm, the method further comprising:
accessing, by the one or more application-specific processing engines, and from the memory of the DSP system, the reconfigured microcode; and
executing, by the one or more application-specific processing engines, and based on the reconfigured microcode, a second matrix-based arithmetic algorithm, wherein the second matrix-based arithmetic algorithm is different from the first matrix-based arithmetic algorithm.

6. The method of claim 1, receiving the one or more input matrices comprises receiving, by the one or more application-specific processing engines, a 2×2 input matrix, a 4×4 input matrix, or an 8×8 input matrix.

7. The method of claim 1, further comprising:
storing the output corresponding to the completed execution of the matrix-based arithmetic algorithm to the memory of the DSP system.

8. A digital signal processor (DSP) including one or more application-specific processing engines implemented on the DSP, comprising:
a memory including instructions; and
a DSP coupled to the memory, the DSP configured to execute the instructions to:
access, by one or more application-specific processing engines, and from the memory of the DSP system, a configurable microcode, wherein the configurable microcode comprises a set of instructions configured to cause the one or more application-specific processing engines to execute a matrix-based arithmetic algorithm; and
execute, by the one or more application-specific processing engines, and based on the configurable microcode, the matrix-based arithmetic algorithm, wherein executing the matrix-based arithmetic algorithm comprises:
receiving, by the one or more application-specific processing engines, one or more input matrices;
performing, by the one or more application-specific processing engines, a plurality of computations based on the one or more input matrices by iteratively executing one or more of a predetermined set of arithmetic operations until the execution of the matrix-based arithmetic algorithm is completed; and
generating, by the one or more application-specific processing engines, an output corresponding to the completed execution of the matrix-based arithmetic algorithm.

9. The DSP system of claim 8, wherein the instructions to execute the matrix-based arithmetic algorithm further comprise instructions to execute, by the one or more application-specific processing engines, and based on the configurable microcode, one or more of a Cholesky decomposition algorithm, a general matrix multiplication (GeMM) algorithm, a triangular solve matrix (TRSM) algorithm, or a triangular matrix matrix multiplication (TRMM) algorithm.

10. The DSP system of claim 8, wherein the instructions to iteratively execute one or more of the predetermined set of arithmetic operations further comprise instructions to iteratively execute one or more of a multiplication operation, a reciprocal square root operation, or a reciprocal function operation.

11. The DSP system of claim 8, wherein the one or more application-specific processing engines comprises an arithmetic logic unit (ALU) configured to execute the one or more of the predetermined set of arithmetic operations.

12. The DSP system of claim 8, wherein the configurable microcode is reconfigured, and wherein the matrix-based arithmetic algorithm comprises a first matrix-based arithmetic algorithm, the instructions further comprising instructions to:
access, by the one or more application-specific processing engines, and from the memory of the DSP system, the reconfigured microcode; and
execute, by the one or more application-specific processing engines, and based on the reconfigured microcode, a second matrix-based arithmetic algorithm, wherein the second matrix-based arithmetic algorithm is different from the first matrix-based arithmetic algorithm.

13. The DSP system of claim 8, wherein the instructions to receive the one or more input matrices further comprise instructions to receive, by the one or more application-specific processing engines, a 2×2 input matrix, a 4×4 input matrix, or an 8×8 input matrix.

14. The DSP system of claim 8, wherein the instructions further comprise instructions to:
store the output corresponding to the completed execution of the matrix-based arithmetic algorithm to the memory of the DSP system.

15. A non-transitory computer-readable medium comprising instructions that, when executed by a digital signal processor (DSP) including one or more application-specific processing engines implemented on the DSP, cause the DSP to:
access, by the one or more application-specific processing engines, and from a memory of the DSP system, a configurable microcode, wherein the configurable microcode comprises a set of instructions configured to cause the one or more application-specific processing engines to execute a matrix-based arithmetic algorithm; and
execute, by the one or more application-specific processing engines, and based on the configurable microcode, the matrix-based arithmetic algorithm, wherein executing the matrix-based arithmetic algorithm comprises:
receiving, by the one or more application-specific processing engines, one or more input matrices;
performing, by the one or more application-specific processing engines, a plurality of computations based on the one or more input matrices by iteratively executing one or more of a predetermined set of arithmetic operations until the execution of the matrix-based arithmetic algorithm is completed; and
generating, by the one or more application-specific processing engines, an output corresponding to the completed execution of the matrix-based arithmetic algorithm.

16. The non-transitory computer-readable medium of claim 15, wherein the instructions to execute the matrix-based arithmetic algorithm further comprise instructions to execute, by the one or more application-specific processing engines, and based on the configurable microcode, one or more of a Cholesky decomposition algorithm, a general matrix multiplication (GeMM) algorithm, a triangular solve matrix (TRSM) algorithm, or a triangular matrix matrix multiplication (TRMM) algorithm.

17. The non-transitory computer-readable medium of claim 15, wherein the instructions to iteratively execute one or more of the predetermined set of arithmetic operations further comprise instructions to iteratively execute one or more of a multiplication operation, a reciprocal square root operation, or a reciprocal function operation.

18. The non-transitory computer-readable medium of claim 15, wherein the one or more application-specific processing engines comprises an arithmetic logic unit (ALU) configured to execute the one or more of the predetermined set of arithmetic operations.

19. The non-transitory computer-readable medium of claim 15, wherein the configurable microcode is reconfigured, and wherein the matrix-based arithmetic algorithm comprises a first matrix-based arithmetic algorithm, the instructions further comprising instructions to:
access, by the one or more application-specific processing engines, and from the memory of the DSP system, the reconfigured microcode; and
execute, by the one or more application-specific processing engines, and based on the reconfigured microcode, a second matrix-based arithmetic algorithm, wherein the second matrix-based arithmetic algorithm is different from the first matrix-based arithmetic algorithm.

20. The non-transitory computer-readable medium of claim 15, wherein the instructions to receive the one or more input matrices further comprise instructions to receive, by the one or more application-specific processing engines, a 2×2 input matrix, a 4×4 input matrix, or an 8×8 input matrix.
